(19) United States
(12) Patent Application Publication
(10) Pub. No.: US 2014/0367429 A1
(43) Pub. Date: Dec. 18, 2014

(54) Hands-free car shoulder harness cell phone holder

(71) Applicant: Paul Joseph Duran, West Hills, CA (US)

(72) Inventor: Paul Joseph Duran, West Hills, CA (US)

(21) Appl. No.: 13/986,878

(22) Filed: Jun. 14, 2013

(51) Int. Cl. B60R 7/04

(52) U.S. Cl. CPC B60R 7/04
USPC 224/275

(57) ABSTRACT

The Hands-Free Car Shoulder Harness Cell Phone Holder is a device that securely holds a cell phone in a mesh elastic pocket and attaches said pocket and cell phone firmly to the shoulder harness portion of an automobile's seat belt. This allows hands-free use of a cell phone in the speaker mode or with an earpiece while safely operating an automobile within the confines of the law.

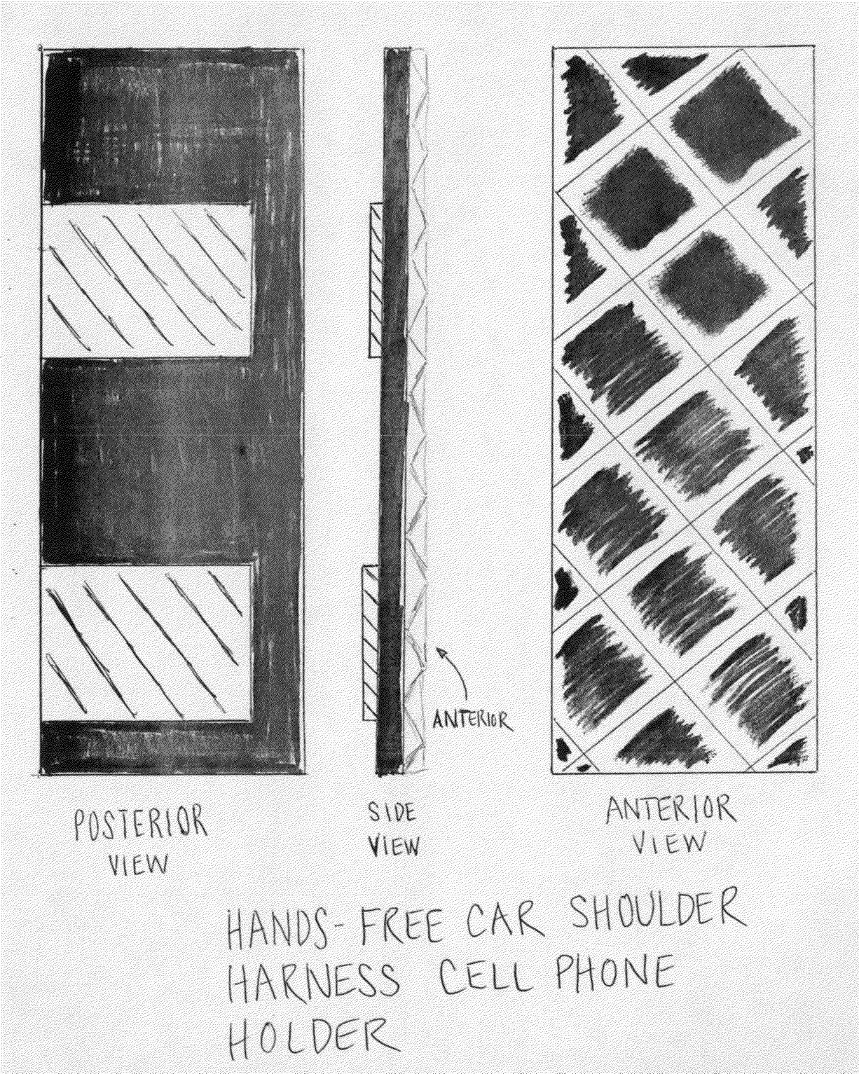

### MANNER/PROCESS OF MAKING SAID INVENTION

The Hands-Free Car Shoulder Harness Cell Phone Holder will consist of 4 (four) parts: 1 (one) elastic, mesh pocket (which will accommodate and tightly hold cell phones up to 7″ by 3.5″ and one thousand grams in weight), 1 (one) firm, stable backing (roughly 7″ long and 2.5″ wide, which will provide stability for cell phones up to and including the same dimensions and weight mentioned previously), and 2 (two) firm, stable clips, each roughly 2″ long and 1.5″ wide (which will firmly attach to the shoulder part of the car seat belt, holding the cell phone in place for safe use while operating an automobile within the confines of the law).

The firm, stable backing will have an anterior and posterior side. The anterior side will be firmly attached to the elastic, mesh pocket. The posterior side will be firmly and permanently attached to the two clips. The two clips will attach said holder to the shoulder portion of the car seat belt.

The elastic, mesh pocket will be manufactured from highly elastic mesh, capable of adequate stretching to accommodate the cell phone and elastic enough to hold the cell phone firmly against the stable backing of said cell phone holder. Said mesh pocket will be firmly and permanently attached on the left, right and bottom sides of said stable backing. The top portion of the mesh pocket will remain unattached and open to allow the user to place the cell phone into the holder prior to safe and appropriate use of said holder. Once the phone is placed in said mesh pocket, the elasticity of the pocket will hold the cell phone firmly in place.

The firm, stable backing will be manufactured from recyclable plastics and/or green, biodegradable products that meet the necessary firmness and stability characteristics. Its approximate dimensions will be 7″ long, 2.5″ wide and 0.25″ thick.

The two firm, stable clips will be manufactured from recyclable plastics and/or biodegradable products that meet the necessary firmness and stability characteristics.

### USE OF SAID INVENTION

The Hands-Free Car Shoulder Harness Cell Phone Holder is to be firmly attached, prior to initiating driving, by its clips to the shoulder portion of the automobile driver's seatbelt within hearing distance of the driver, when the cell phone is in the speakerphone mode. This position will also accommodate the use of an earpiece component. The cell phone is to be placed securely into said phone holder's mesh pocket. The mesh will allow ease of connection of the earpiece component to the cell phone. The mesh will also allow the sound waves from the cell phone to travel unimpeded from the cell phone's speaker to the driver's ear and, conversely, from the driver's voice to the cell phone's microphone in the same unhindered fashion. The use of this cell phone holder will allow the driver of the automobile to conduct a cell phone conversation in a hands-free, safe and legal manner.

### BRIEF DESCRIPTION OF DRAWINGS OF INVENTION

Posterior View—This view demonstrates the firm stable backing (the “solid black” portion of drawing) which is 2.5″ wide and 7″ tall. Said view also demonstrates the two (2) firm stable clips (the “white with diagonal black lines-running from left to right” portion of the drawing), each of which is 2″ wide and 1.5″ tall.

Side View—This view demonstrates (from left to right on the page) the two (2) firm stable clips (the “white with diagonal black lines-running from left to right” portion of the drawing), each of which is 1.5″ tall and 0.125″ thick; the firm stable backing (the “solid black” portion of the drawing), which is 7″ tall and 0.25″ thick; and the elastic mesh pocket (the “zigzag pattern” portion of the drawing) which is 7″ tall and 0.25″ thick.

Anterior View—This view demonstrates the elastic mesh pocket (the “zigzag pattern” portion of the drawing), which is 2.5″ wide and 7″ tall. This view also demonstrates the firm stable backing (the “black” portion of the drawing) which is 2.5″ wide and 7″ tall and is posterior to the mesh pocket in this view.

1. I am the sole inventor of this product as described to the best of my ability in this document. I have never seen or heard of any similar product. I have never been told in any way, shape or form that any other person has thought of this type of product, the Hands-Free Car Shoulder Harness Cell Phone Holder.
